(19) United States
(12) Patent Application Publication
(10) Pub. No.: US 2022/0228522 A1
(43) Pub. Date: Jul. 21, 2022

(54) RADIATOR-INTERCOOLER INTEGRATED MODULE AND VEHICLE INCLUDING THE SAME

(71) Applicants: Hyundai Motor Company, Seoul (KR); Kia Corporation, Seoul (KR)

(72) Inventors: Seung Jae Kang, Seoul (KR); Won Rok Choi, Seoul (KR); Hyun Jin Park, Incheon (KR)

(21) Appl. No.: 17/405,567

(22) Filed: Aug. 18, 2021

(30) Foreign Application Priority Data
Jan. 18, 2021 (KR) 10-2021-0006722

(51) Int. Cl. F01P 3/20; F02B 29/04; F01P 7/16; B60K 11/04; F01P 3/18; F01P 11/04

(52) U.S. Cl. CPC F01P 3/20; F02B 29/0443; F01P 7/165; F01P 2060/12; F01P 3/18; F01P 11/04; F01P 2060/02; B60K 11/04

(57) ABSTRACT

A radiator-intercooler integrated module and a vehicle including the same are provided. The radiator-intercooler integrated module includes a low-temperature radiator and a water cooled intercooler of the vehicle which are integrated into a single body.

### CROSS-REFERENCE TO RELATED APPLICATION

This application claims under 35 U.S.C. § 119(a) the benefit of priority to Korean Patent Application No. 10-2021-0006722 filed on Jan. 18, 2021, the entire contents of which are incorporated herein by reference.

### BACKGROUND

### (a) Technical Field

The present disclosure relates to a radiator-intercooler integrated module and a vehicle including the same, and more particularly, to a radiator-intercooler integrated module into which a low-temperature radiator and a water cooled intercooler of a vehicle are integrated.

### (b) Background Art

A vehicle in which a turbocharger is mounted is equipped with an intercooler for cooling heat generated by charging air. The intercooler is classified into an air cooled intercooler that cools charged air using air supplied during driving and a water cooled intercooler that cools the charged air using a coolant.

Recently, there has been a tendency to adopt the water cooled intercooler. Considerate change in an engine system is required to mount the water cooled intercooler on an engine. For example, an overall change in the front region of the vehicle is required to additionally mount a low-temperature radiator through which a coolant for heat exchange with the charged air flows. Further, in case of the water cooled intercooler, a number of components are added in comparison with the air cooled intercooler. At least for these reasons, the water cooled intercooler has a complicated structure, and a layout configuration of the components of the water cooled intercooler becomes difficult.

### SUMMARY

The present disclosure has been made in an effort to solve the above-described problems associated with prior art. In one aspect, the present disclosure provides a radiator-intercooler integrated module capable of simplifying a structure thereof, and simplifying layout design of a front region of a vehicle for a water cooled intercooler.

Objectives of the present disclosure are not limited to the above-described objectives, and other objectives of the present disclosure, which are not mentioned, can be clearly understood from the following description by those having ordinary skill in the art which the present disclosure pertains. The features of the present disclosure for achieving the above objectives of the present disclosure and performing the following characteristic functions of the present disclosure, which will be described later, are as follows.

In some embodiments of the present disclosure, a radiator-intercooler integrated module may include: a low-temperature radiator and a water cooled intercooler formed integrally with the low-temperature radiator into a single body. In some embodiments of the present disclosure, a radiator-intercooler integrated module may include: a low-temperature radiator having a radiator core, the low-temperature radiator including an inlet tank and exit tank disposed above and below the radiator core, respectively, and communicating with the radiator core; and a water cooled intercooler which has a cooling core inserted and mounted in the exit tank, wherein compressed air flows in the cooling core.

In some embodiments of the present disclosure, a vehicle may include: a turbocharger configured to charge air; a radiator-intercooler integrated module having a water cooled intercooler receiving the charged air from the turbocharger and a low-temperature radiator formed integrally with the water cooled intercooler. A coolant configured to exchange heat with the air circulates the low-temperature radiator and an intake manifold receiving the heat-exchanged air discharged from the radiator-intercooler integrated module.

According to the present disclosure, it is possible to provide a radiator-intercooler integrated module capable of simplifying layout design of a front region of a vehicle even if a water cooled intercooler instead of an air cooled intercooler is applied to cool supercharged air. Effects of the present disclosure are not limited to the above-mentioned effects. Other unmentioned effects can be clearly recognized from the following description by those having ordinary skill in the art.

### BRIEF DESCRIPTION OF THE DRAWINGS

The above and other features of the present disclosure will now be described in detail with reference to exemplary embodiments thereof illustrated in the accompanying drawings which are given hereinbelow by way of illustration only, and thus are not limitative of the present disclosure, and wherein:

FIG. 1 is a side view illustrating a radiator-intercooler integrated module according to an embodiment of the present disclosure;

FIG. 2A is a perspective view illustrating a low-temperature radiator of the radiator-intercooler integrated module according to an embodiment of the present disclosure;

FIG. 2B is a perspective view illustrating a radiator-intercooler integrated module according to another embodiment of the present disclosure;

FIG. 3 is a view illustrating a state in which a part of the low-temperature radiator of the radiator-intercooler integrated module according to the embodiment of the present disclosure is removed;

FIG. 4 is a view illustrating an intercooler of the radiator-intercooler integrated module according to the embodiment of the present disclosure;

FIG. 5A is a sectional view taken along line A-A′ of FIG. 3 and illustrating the case where an exit tank is disposed on an upper side of a radiator core;

FIG. 5B is a sectional view taken in the same direction as in FIG. 5A and illustrating the case where the exit tank is disposed on a lower side of a radiator;

FIG. 6 is a general scheme illustrating a layout of a general front region of a vehicle;

and

FIG. 7 is a view schematically illustrating a layout of a front region of a vehicle in which the radiator-intercooler integrated module according to the embodiment of the present disclosure is mounted.

### DETAILED DESCRIPTION

Hereinafter, exemplary embodiments of the present disclosure will be described in detail with reference to the accompanying drawings. Specific structures or functions described in the embodiments of the present disclosure are merely for illustrative purposes. Embodiments according to the concept of the present disclosure may be implemented various forms, and it should be understood that they should not be construed as being limited to the embodiments described in the present specification, but include all of modifications, equivalents, or substitutes included in the spirit and scope of the present disclosure.

It will be understood that, although the terms “first,” “second,” etc. may be used herein to describe various elements, these elements should not be limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it can be directly coupled or connected to the other element or intervening elements may be present therebetween. In contrast, it should be understood that when an element is referred to as being “directly coupled” or “directly connected” to another element, there are no intervening elements present. Other expressions that explain the relationship between elements, such as “between,” “directly between,” “adjacent to,” or “directly adjacent to,” should be construed in the same way.

Like reference numerals denote like components throughout the specification. In the meantime, the terminology used herein is for the purpose of describing particular embodiments only and is not intended to be limiting. As used herein, the singular forms “a,” “an,” and “the” are intended to include the plural forms as well, unless the context clearly indicates otherwise. It will be further understood that the terms “comprise,” “include,” “have,” etc., when used in this specification, specify the presence of stated components, steps, operations, and/or elements, but do not preclude the presence or addition of one or more other components, steps, operations, and/or elements thereof.

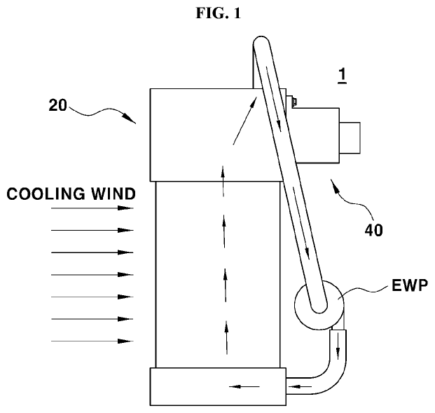

Hereinafter, the present disclosure will be described in detail with reference to the accompanying drawings. As illustrated in FIG. 1, a radiator-intercooler integrated module 1 according to the present disclosure may include a low-temperature radiator 20 and a water cooled intercooler 40. The low-temperature radiator 20 and the water cooled intercooler 40 are integrated as a single assembly.

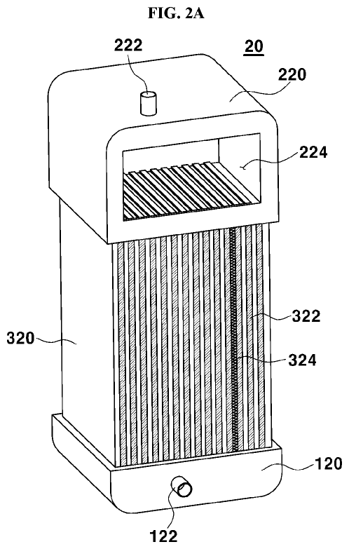

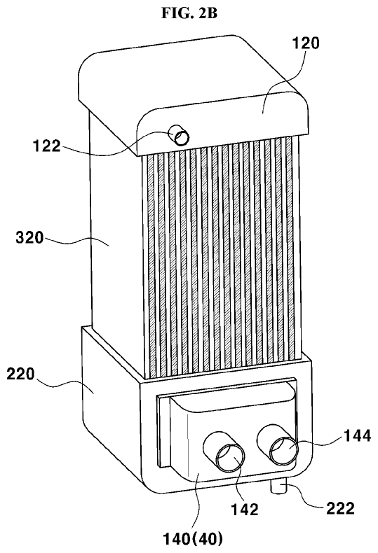

Referring to FIGS. 2A and 2B, the low-temperature radiator 20 may include an inlet tank 120, an exit tank 220, and a radiator core 320. The inlet tank 120 and the exit tank 220 are disposed at each side of the radiator core 320. According to an exemplary embodiment of the present disclosure, as illustrated in FIG. 2A, when the radiator-intercooler integrated module according to the present disclosure is mounted in a vehicle, the inlet tank 120 is disposed below the radiator core 320, and the exit tank 220 is disposed above the radiator core 320. According to another exemplary embodiment of the present disclosure, as illustrated in FIG. 2B, when the radiator-intercooler integrated module according to the present disclosure is mounted in a vehicle, the exit tank 220 is disposed below the radiator core 320, and the inlet tank 120 is disposed above the radiator core 320. Hereinafter, the present invention is described based on which the inlet tank 120 is disposed below the radiator core 320. However, as described above, the positions of the inlet tank 120 and the exit tank 220 may be changed.

The inlet tank 120 may include a water inlet 122. The water inlet 122 may be supplied with a coolant from a coolant supply source or an electric water pump (EWP). The radiator core 320 may be disposed above the inlet tank 120. On the contrary, as described above, when the exit tank 220 is disposed below the radiator core 320 and the inlet tank 120 is disposed above the radiator core 320, the radiator core 320 may be disposed below the inlet tank 120. The radiator core 320 may include coolant pipelines 322 along which a coolant flows. The coolant of the inlet tank 120 which is introduced from the water inlet 122 flows through the radiator core 320. Heat exchange between cooling wind passing the radiator core 320 and the coolant passing the coolant pipelines 322 occurs at the radiator core 320. A plurality of radiator cooling fins 324 may be provided to the radiator core 320 along the coolant pipelines 322 and promote cooling of the coolant while the cooling wind passes the radiator cooling fins 324.

The exit tank 220 may be disposed above the radiator core 320. On the contrary, as described above, when the inlet tank 120 is disposed above the radiator core 320, the exit tank 220 may be disposed below the radiator core 320. The coolant cooled while passing the radiator core 320 may be introduced into the exit tank 220. The exit tank 220 may be equipped with a water outlet 222. The coolant passing the exit tank 220 may be discharged to the outside of the radiator-intercooler integrated module 1 through the water outlet 222. The coolant recirculates around the radiator-intercooler integrated module 1 through the electric water pump (EWP). The exit tank 220 may include an opening 224 that passes through a part of the exit tank 220. A holding space S is provided inside the exit tank 220.

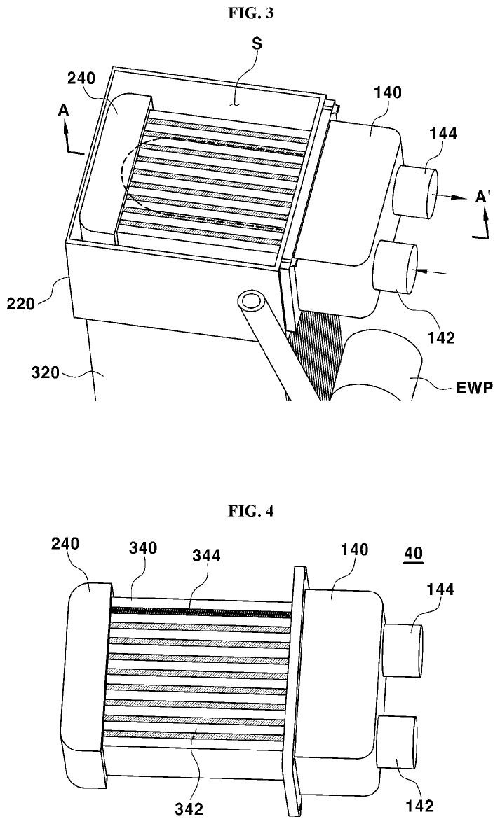

As illustrated in FIGS. 3 and 4, the water cooled intercooler 40 is integrated into the low-temperature radiator 20. In particular, the water cooled intercooler 40 is mounted on the exit tank 220 and is received in the holding space S. The water cooled intercooler 40 may include a first tank 140, a second tank 240, and a cooling core 340. The first tank 140 and the second tank 240 may be disposed at each side of the cooling core 340. The first tank 140 may have an air inlet 142 and an air outlet 144. Compressed air of a turbocharger may be introduced into the air inlet 142. The air flowing into the outlet tank 220 through the air inlet 142 may be discharged through the air outlet 144. According to an exemplary embodiment of the present disclosure, the first tank 140 may protrude from the exit tank 220 and, more particularly, may protrude from the opening 224.

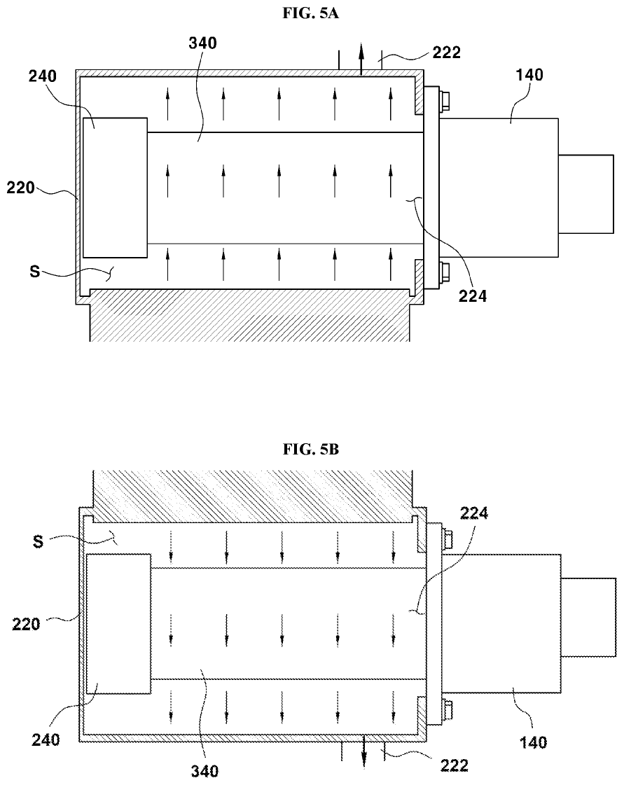

Air introduced into the first tank 140 passes the cooling core 340. As indicated by an arrow and a dotted line of FIG. 3, the compressed air supplied through the turbocharger is introduced into the first tank 140 through the air inlet 142, cooled through the cooling core 340, and then discharged through the air outlet 144 of the first tank 140. The cooling core 340 may include air pipelines 342 through which the compressed air introduced into the first tank 140 may flow. As illustrated in FIG. 5A, the compressed air passing the air pipelines 342 is configured to exchange heat with the coolant passing the radiator core 320 and then flow in the outlet tank 220 from the radiator core 320, thereby reducing a temperature thereof. Arrows of FIG. 5A indicate a flow direction of the coolant.

In other words, the coolant inside the low-temperature radiator 20 may be cooled by the cooling wind. The coolant cooled in this way cools the compressed air introduced into the cooling core 340 in the exit tank 220 while passing the water cooled intercooler 40. Meanwhile, FIG. 5A illustrates a case where the exit tank 220 is disposed above the radiator core 320 and the coolant moves up from bottom to top. On the contrary, FIG. 5B illustrates a flow direction of the coolant that moves down from top to bottom when the exit tank 220 is disposed below the radiator core 320.

According to an exemplary embodiment of the present disclosure, a plurality of intercooler cooling fins 344 are provided along the air pipelines 342. The intercooler cooling fins 344 enables a coolant to more effectively cool air inside the air pipelines 342 while the coolant passes by the air pipelines 342. The compressed air passing the air pipelines 342 may pass the second tank 240, pass the air pipelines 342 again, and return to the first tank 140. The cooled compressed air returning to the first tank 140 exits through the air outlet 144 and is supplied to an intake manifold 610.

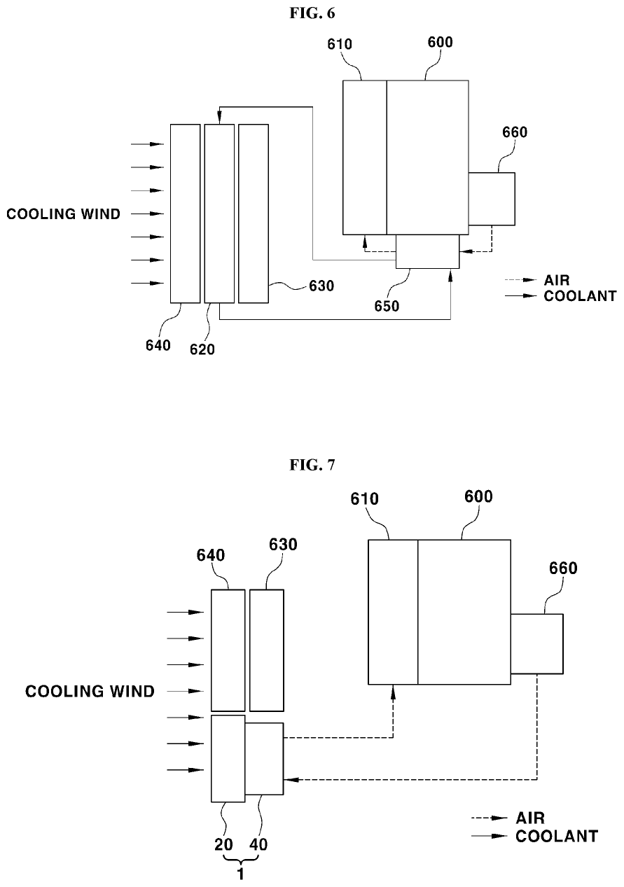

FIG. 6 illustrates an exemplary front region of a vehicle in which a water cooled intercooler is mounted, and FIG. 7 illustrates a front region of a vehicle in which the radiator-intercooler integrated module according to the present disclosure is mounted. As illustrated in FIG. 6, a heat exchanger including a radiator and a condenser is generally disposed in front of an engine 600 and an intake manifold 610 of a vehicle. In the vehicle to which the water cooled intercooler is applied, a low-temperature radiator 620 is typically disposed in front of a high-temperature radiator 630 disposed in the front region of a vehicle, and is disposed between a condenser 640 and the high-temperature radiator 630. The high-temperature radiator 630 is configured to cool an engine coolant, and the low-temperature radiator 620 is configured to cool a coolant of a water cooled intercooler 650.

Charged air passing a turbocharger 660 may be cooled while passing the water cooled intercooler 650 and is delivered to the intake manifold 610. The cooling of the charged air may be performed at the low-temperature radiator 620 and by the coolant circulating through the water cooled intercooler 650. In contrast, in the present disclosure illustrated in FIG. 7, the low-temperature radiator 20 is juxtaposed with the condenser 640. Accordingly, the low-temperature radiator 20 may be cooled without a loss of cooling wind, and thus a size of the low-temperature radiator 20 may be reduced.

Further, since the water cooled intercooler 40 is integrated into the low-temperature radiator 20, a structure of the radiator-intercooler integrated module may be simplified, and thus an effect of reducing an overall cost may be achieved. According to the present disclosure, the low-temperature radiator 20 and the water cooled intercooler 40 are mounted at a position where the air cooled intercooler is disposed in the related art. Accordingly, there is no need to change the layout or the engine structure of the vehicle, thereby reducing investment expenses.

To satisfy the increasingly stricter emission control limits, there is a need to expand a usable range of low-pressure exhaust gas recirculation (LPEGR). The air cooled intercooler has a limitation due to a low-temperature freezing problem, whereas the water cooled intercooler may enable expansion of the usable range of the LPEGR in that cooling efficiency can be controlled using the electric water pump and without the freezing problem. According to the present disclosure, the radiator-intercooler integrated module may be mounted at the same position as the conventional air cooled intercooler is mounted, while applying the water cooled intercooler, thereby solving a problem with mounting of the water cooled intercooler.

The present disclosure described above is not limited by the above-mentioned embodiments and the attached drawings, and it will be apparent to those having ordinary skills in the art that various substitutions, modifications, and changes are possible without departing from the technical spirit of the present disclosure.

What is claimed is:

1. A radiator-intercooler integrated module, comprising:
a low-temperature radiator; and
a water cooled intercooler formed integrally with the low-temperature radiator into a single body.

2. The radiator-intercooler integrated module of claim 1, wherein the low-temperature radiator includes:
an inlet tank into which a coolant flows;
a radiator core disposing the coolant in heat exchange relationship with the coolant, wherein the coolant from the inlet tank flows into the radiator core; and
an exit tank, wherein the coolant passing through the radiator core flows into the exit tank.

3. The radiator-intercooler integrated module of claim 2, wherein the water cooled intercooler is inserted and disposed in the exit tank.

4. The radiator-intercooler integrated module of claim 2, wherein the exit tank includes:
an opening formed by opening a part of the exit tank; and
a holding space forming an empty space inside the opening.

5. The radiator-intercooler integrated module of claim 4, wherein the water cooled intercooler is seated in the holding space, and a portion of the water cooled intercooler protrudes through the opening.

6. The radiator-intercooler integrated module of claim 2, wherein a plurality of radiator cooling fins are formed along the radiator core.

7. A radiator-intercooler integrated module comprising:
a low-temperature radiator having a radiator core, wherein the low-temperature radiator includes an inlet tank and exit tank disposed above and below the radiator core, respectively, and is configured to communicate with the radiator core; and
a water cooled intercooler having a cooling core inserted and mounted in the exit tank, wherein compressed air flows in the cooling core.

8. The radiator-intercooler integrated module of claim 7, wherein a coolant flows from an electric water pump into the inlet tank.

9. The radiator-intercooler integrated module of claim 8, wherein the radiator core includes coolant pipelines where the coolant flowing from the inlet tank flows.

10. The radiator-intercooler integrated module of claim 9, wherein the coolant passing the coolant pipelines flows into the exit tank, and the coolant is disposed in heat exchange relationship with the compressed air.

11. The radiator-intercooler integrated module of claim 10, wherein the water cooled intercooler further includes an air inlet and a first tank, wherein the compressed air flows from an outside into the air inlet and the first tank communicates with the cooling core.

12. The radiator-intercooler integrated module of claim 11, wherein the first tank includes an air outlet discharging the air passing the cooling core

13. The radiator-intercooler integrated module of claim 7, wherein a plurality of intercooler cooling fins are formed along the cooling core.

14. A vehicle comprising:
a turbocharger configured to charge air;
a radiator-intercooler integrated module having a water cooled intercooler configured to receive the charged air from the turbocharger and a low-temperature radiator formed integrally with the water cooled intercooler, wherein a coolant that exchanges heat with the air circulates the low-temperature radiator; and
an intake manifold configured to receive the heat-exchanged air discharged from the radiator-intercooler integrated module.

15. The radiator-intercooler integrated module of claim 14, wherein the radiator-intercooler integrated module is juxtaposed with a condenser disposed in the front of the vehicle in a width direction of the vehicle.
